(19) United States
(12) Patent Application Publication
(10) Pub. No.: US 2026/0219451 A1
(43) Pub. Date: Jul. 30, 2026

(54) A TWISTED WAVEGUIDE CONFIGURED FOR ELLIPTICAL POLARIZATION TRANSFORMATION, AND SYSTEMS FOR UTILIZING THE SAME

(71) Applicant: ALINA KARABCHEVSKY, Lehavim (IL)

(72) Inventors: Alina KARABCHEVSKY, Lehavim (IL); Fedar MAROZKA, Modiin-Maccabim-Reut (IL)

(21) Appl. No.: 19/143,194

(22) PCT Filed: Dec. 25, 2023
(86) PCT No.: PCT/IL2023/051308

§ 371 Date: Jun. 25, 2025

Related U.S. Application Data
(60) Provisional application No. 63/435,279, filed on Dec. 26, 2022.
(60) Provisional application No. 63/545,242, filed on Oct. 23, 2023.

(51) Int. Cl. G02B 6/126; G02B 6/13

(52) U.S. Cl. CPC G02B 6/126; G02B 6/13

(57) ABSTRACT

The invention relates to a method for creating a twisted waveguide capable of exhibiting elliptical birefringence, the method comprising: for a given light frequency f and cross-section of a waveguide described by a permittivity profile ε(X, Y) calculating a linear birefringence λ, thereby to determine and apply parameters L, θ, and a twist rate θ/L that satisfy a condition that the twisted waveguide's twist rate is of a same order of magnitude as a linear birefringence rate occurred when assuming that the waveguide is untwisted; where f is the frequency of light, ε(X, Y) is permittivity along X-Y axes of the twisted waveguide at the frequency f, respectively, L is the waveguide's length, and θ is a twist angle of the waveguide.

### FIELD OF THE INVENTION

The field of the invention generally relates to quantum processing, specifically to a twisted waveguide configured for elliptical polarization transformation, and systems utilizing the same.

### BACKGROUND OF THE INVENTION

Integrated photonics is a remarkable platform for scalable classical and quantum light-based information processing. However, despite its fundamental significance in information processing, polarization manipulation on a chip remains elusive.

One or more of the photon's physical degrees of freedom, such as path, linear momentum, angular momentum, and polarization, can be potentially utilized to encode information at a single photon level. Utilizing more than one of the photon's degrees of freedom is desirable to reach a higher information processing capability per chip footprint. Photon polarization is an always-available natural degree of freedom and is thus among the most widely used encoding mechanisms. Furthermore, to benefit from using an integrated platform, it is crucial to perform most or ideally all light manipulations on a chip as most losses occur at a stage of coupling light into a chip or from a chip. However, despite the recognized strength of integrated photonics in controlling light, manipulating polarization on a chip has not been optimized yet. Although an integrated photonic polarization-encoded CNOT gate has been demonstrated in laser-written chips, polarization manipulation has been so far performed using either bulk or fiber optics. On-chip polarization manipulation schemes based on tilted-based waveguides typically serve as waveplates, where the waveguide symmetry axis exhibits the optical axis. Such schemes, however, suffer from several drawbacks: they are susceptible to fabrication tolerances and tend to have significant coupling losses due to the cross-section mismatch with conventional waveguides.

In another aspect, polarization manipulation capabilities have recently been demonstrated in femtosecond laser-inscribed twisted waveguides; however, a systematic theoretical description of polarization manipulation has not been fully established for this architecture. Due to the recent advances in integrated photonics fabrication technology, especially in laser writing, the integrated photonic twisted waveguides have become a reality and have already been suggested as broadband adiabatic polarization rotators. Several effects were observed in twisted waveguides that cannot be easily explained by the adiabatic mode evolution principle: (a) a decrease of polarization conversion efficiency with the increase of the twist length; and (b) spectral oscillations of polarization conversion efficiency.

R. Ulrich and A. Simon, “Polarization optics of twisted single-mode fibers”, Applied Optics 18, 2241 (1979), disclosed that nontrivial polarization dynamics occur in twisted birefringent fibers due to the interplay of linear and circular birefringence.

WO 2021/149044 discloses a twisted waveguide operating as a linear polarization rotator. WO 2022/038590 discloses an entangled photon pair source that utilizes the capability of a twisted waveguide to change the polarization of a pair of photons linearly.

To summarize all the above, the functionality of the prior art's twisted waveguides has been so far limited only to linear polarization of light or qubits.

A general object of the invention is to broaden the functionality of twisted waveguides.

Another object of the invention is to provide a twisted waveguide operating in a non-linear polarization.

Still, another object of the intervention is to provide a twisted waveguide capable of operating within a system performing arbitrary polarization transformations.

Still, another object of the invention is to provide a twisted waveguide operating as a single-qubit gate.

Still, another object of the invention is to provide a twisted waveguide-based system operating as a qubit encoder.

Other objects and advantages of the invention become apparent as the description proceeds.

### SUMMARY OF THE INVENTION

The invention relates to a method for creating a twisted waveguide capable of exhibiting elliptical birefringence, the method comprising:
for a given light frequency f and cross-section of a waveguide described by a permittivity profile ε(X,Y), calculating a linear birefringence λ, thereby to determine and apply parameters L, θ, and a twist rate θ/L that satisfy a condition that the twisted waveguide's twist rate is of a same order of magnitude as a linear birefringence rate occurred when assuming that the waveguide is untwisted;
where f is the frequency of light, ε(X,Y) is permittivity along X-Y axes of the twisted waveguide at the frequency f, respectively, L is the waveguide's length, and θ is a twist angle of the waveguide.

In an embodiment of the invention, the linear birefringence λ is a propagation constant difference β_{TE}-β_{TM} of TE and TM modes, respectively, within an untwisted waveguide having said permittivity profile.

In an embodiment of the invention, a pitch of the waveguide twist

$$Λ = \frac{2 π}{θ} L$$

has a same order of magnitude as a polarization beat length L_{B} of an untwisted waveguide having a same cross-section as said twisted waveguide.

In an embodiment of the invention, the method further uses the twisted waveguide as an arbitrary waveplate.

In an embodiment of the invention, the waveplate operates with classical light, and is reconfigurable.

In an embodiment of the invention, the method further uses the twisted waveguide as a reconfigurable single-qubit gate capable of performing unitary transformations on polarization qubits.

In an embodiment of the invention, the method further uses the twisted waveguide as a reconfigurable single-qubit gate configured to perform polarization encoding.

In an embodiment of the invention, the reconfiguration is performed by utilizing one or more external signals that modify said twisted waveguide's linear birefringence.

In an embodiment of the invention, the external signals are voltage or temperature modifying substrate material's refractive index affecting said linear birefringence of the twisted waveguide.

In an embodiment of the invention, the method further stacks a plurality of twisted waveguides, all having a same cross section, but possibly different L and 0, each twisted waveguide being controlled with its own independent external signal, and further tuning said signals to achieve arbitrary polarization transformation.

The invention also relates to a twisted waveguide created to exhibit an elliptical polarization transformation, wherein the waveguide is designed such that: for a given light frequency f, cross-section of the waveguide described by a permittivity profile ε(X,Y), and linear birefringence λ within the waveguide, providing parameters L, θ, and a twist rate θ/L that satisfy a condition that the twisted waveguide's twist rate is of a same order of magnitude as a linear birefringence occurred when assuming that the waveguide is untwisted;
where f is the frequency of light, ε(X,Y) is permittivity along X-Y axes of the twisted waveguide, respectively, L is the waveguide's length, and θ is a twist angle of the waveguide.

In an embodiment of the invention, a pitch of the waveguide twist

$$Λ = \frac{2 π}{θ} L$$

is of a same order of magnitude as a polarization beat length L_{B} of an untwisted waveguide having a same cross-section.

In an embodiment of the invention, the twisted waveguide is configured to operate as an arbitrary waveplate.

In an embodiment of the invention, the waveplate is configured to operate with classical light, and is reconfigurable.

In an embodiment of the invention, the twisted waveguide is configured to operate as a single-qubit gate with polarization qubits.

In an embodiment of the invention, the twisted waveguide is reconfigurable to provide polarization encoding.

### BRIEF DESCRIPTION OF THE DRAWINGS

In the drawings:

FIG. 1 generally depicts the structure of a twisted waveguide according to an embodiment of the invention;

FIG. 2a shows a qubit polarization transformation system in a block-diagram form;

FIG. 2b illustrates in a block diagram form a system in which the twisted waveguide is reconfigurable;

FIG. 3 schematically illustrates a twisted waveguide realizing a polarization-encoded single-qubit gate;

FIG. 4a shows qubit polarization states as obtained by the system of the invention, shown on a Bloch sphere;

FIG. 4b shows eigenvalues of the eigenmodes of a twisted waveguide as a function of twist rate, expressed in terms of angle ψ;

FIG. 5(a) shows worst overall fidelity Fₘᵢₙ results calculated for single-qubit gates as a function of twisted waveguide design constraints;

FIGS. 5b-5d show worst fidelity results over various rotations around a given axis with θₘₐₓ=20Π and three different Lₘₐₓ constraints; and

FIGS. 5e-5g illustrate in bar chart forms fidelity distributions relating to FIGS. 5b-5d, respectively.

### DETAILED DESCRIPTION OF PREFERRED EMBODIMENTS

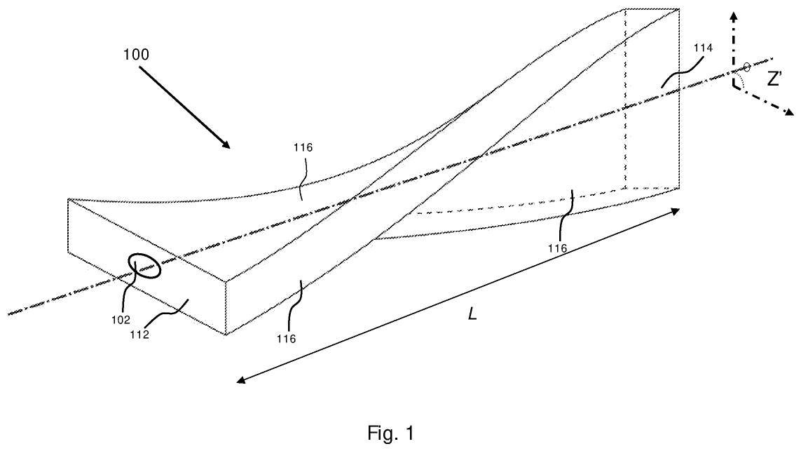

FIG. 1 generally depicts the structure of a twisted waveguide 100, according to an embodiment of the invention. Waveguide 100 has a twisted-cuboid shape and is substantially made from materials such as silicon, silicon nitride, gallium-arsenide (that is compatible with components in the semiconductor industry), or silica (silicon dioxide) or borosilicate or non-linear crystals like KTP (that are compatible with glass-made components and conventional optical fibers). The twisted waveguide 100 has a rectangular input facet 112, a rectangular output facet 114, and four side facets 116. The output facet 114 of the waveguide 100 is twisted (in this specific case θ=90°) about a longitudinal-central axis Z′ relative to the input facet 112. This configuration differs from typical cuboid-shaped prior art waveguides in which the input and output facets have the same orientation relative to a longitudinal-central axis Z′ (as with any pure cuboid body). WO 2021/149044 and WO 2022/038590 disclose that by twisting the waveguide gradually along a portion or all the waveguide's length L, the beam's polarization linearly follows the waveguide's contour, including the twist, altering the polarization of the output beam (WO 2021/149044) or qubit (WO 2022/038590) at the output facet, respectively by a polarization change α=θ. Various other angular polarization rotations α° can be made depending on the respective level of the waveguide's twist θ.

The inventors have found that, upon introducing a polarization qubit 102 at the inlet facet 112, the twisted waveguide 100 can act as a waveplate exhibiting elliptical birefringence. The elliptical birefringence is obtained thanks to an interplay between (a) a linear birefringence caused by 2-fold rotationally-symmetric cross-sectional shape; and (b) a circular birefringence resulting from a topological effect owing to the waveguide's twist. Given this interplay, it can be concluded that a twisted waveguide can act as an on-chip elliptical waveplate capable of implementing arbitrary unitary operations in polarization-encoded quantum and classical information processing circuits.

While the explanation below relates to a cuboid twisted waveguide having rectangular input and output facets, 112 and 114, respectively, other input and output facet cross-sections of twisted waveguides, such as adiabatically tapered, circular, oval, etc., are also applicable as long as the above birefringence interplay conditions are maintained. Moreover, while the following description relates specifically to the polarization transformation of qubits, the description and phenomena discussed are likewise applicable classical monochromatic light sources.

The inventors have found that elliptical birefringence at the twisted waveguide-based system can be achieved by making the twist rate (i.e., θ/L, where L is the twist length and θ is the twist angle) the same or about the same as the polarization beat length. “The same” means a similarity, typically within the same order of magnitude.

The inventors analysed whether an upper bound of the twist angle and twist length limits the implementation of arbitrary polarization transformations. The analysis showed that the higher the transformation fidelity required, the greater the twist angle and length are necessary. For example, twist angles below 360° guarantee 90% fidelity, the worst among all possible transformations checked. However, a) for some specific gates involving elliptical birefringence, the twist angle can be smaller than 360°; b) it is possible to implement a gate with two or more sequentially placed twisted waveguides having different twist lengths and/or angles. In such a configuration, realizing an arbitrary gate with theoretically perfect fidelity at smaller values of total length and twist angle is possible. Furthermore, it should be noted that implementing twist angles above 360° is realistic with femtosecond writing technology.

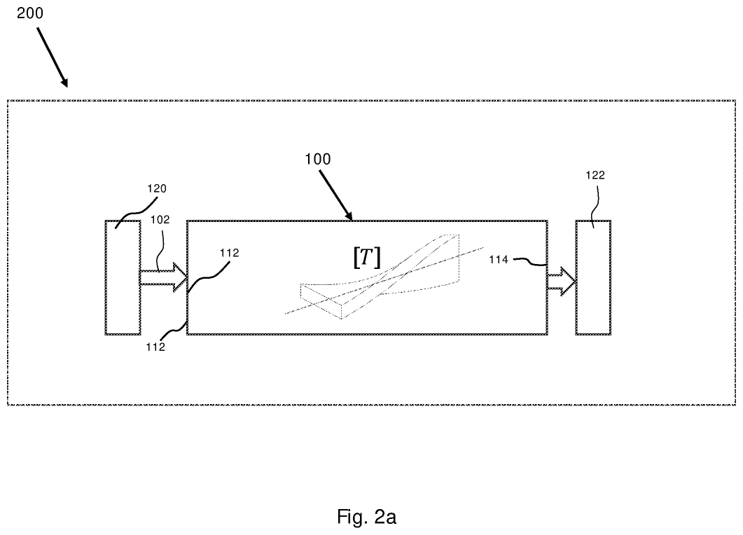

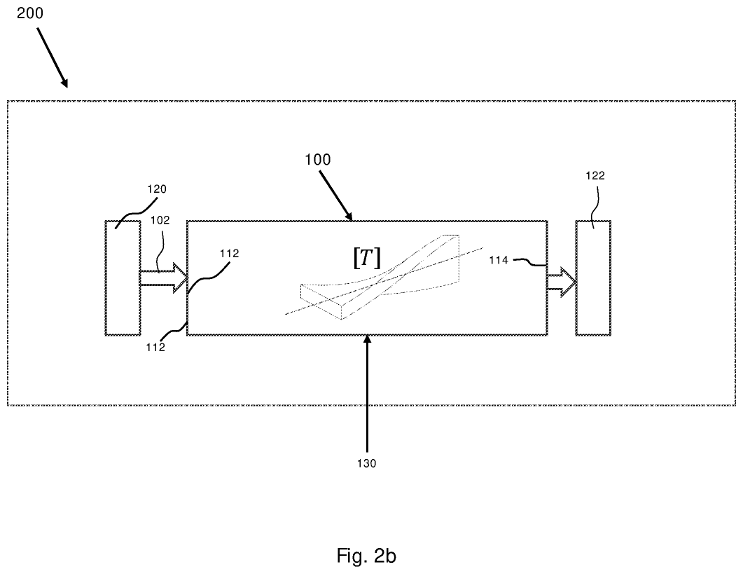

FIG. 2a shows a qubit polarization transformation system 200 in a block-diagram form, according to an embodiment of the invention. Qubits in one or more polarizations arrive at the input facet 112 of twisted waveguide 100, which is designed to provide an elliptical polarization transformation as described above. Based on a transformation matrix [T] (transfer function) that depends on the structure of the twisted waveguide 100 meeting the above-discussed birefringence interplay, waveguide 100 transforms each qubit's input polarization 102 to an output polarization at the output facet 114 while the transformation is described as rotation of the Poincare (Bloch) sphere representing the state of polarization around an arbitrary axis. The inventors refer to such a transformation as elliptical. This elliptical transformation may be observed by sending horizontally or vertically polarized light at the input facet 112 and measuring polarization at the output facet 114 using a polarimeter 122.

Given the elliptical polarization transformation [T] that takes place within the twisted waveguide 100, the entire system 200 can be easily modified to act as one of (a) an arbitrary waveplate; (b) a single-qubit gate for polarization qubits; or (c) a reconfigurable single-qubit gate capable of polarization encoding.

The functionalities (a) and (b) above are architecturally the same, as a waveplate that performs a unitary transformation of a polarization state can also perform a unitary transformation of polarization qubits. To achieve the single qubit gate of (b), the twisted waveguide and a source of single photons should be used. The reconfigurability of the single qubit gate of (c) can be achieved using a thermo-optic or electro-optic effect. The thermo-optic effect is present in arbitrary materials, while the electro-optic effect requires the inclusion of the single qubit gate within a chip made of a suitable material, primarily crystal, e.g., lithium niobate (LiNbO3), potassium titanyl phosphate (KTP), beta-barium borate (BBO) etc.

FIG. 2b illustrates in a block diagram form a system 200 in which the twisted waveguide 100 is reconfigurable (i.e., the transfer matrix [T] is modified) utilizing a thermo-optic or an electro-optic signal 130. The inventors performed analysis proving that a thermo-optic effect can reconfigure such a twisted waveguide's transfer matrix [T]. The inventors also believe that an electro-optic effect can also be used to reconfigure the twisted waveguide.

When fabricated by femtosecond laser inscription technology, combining low-cost fabless and maskless fabrication processes with excellent design flexibility, the invention can form a building block for realizing polarization-encoded quantum information processing integrated circuits.

In one aspect, the invention relates to a method for creating a twisted waveguide capable of exhibiting elliptical birefringence, the method comprising:
For a given light frequency f and cross-section of a waveguide described by a permittivity profile ε(X,Y), calculating a linear birefringence λ, thereby to determine and apply parameters L, θ, and a twist rate θ/L that satisfy a condition that the twisted waveguide's twist rate is of the same order of magnitude as a linear birefringence occurred when assuming that the waveguide is untwisted;
where f is the frequency of light, ε(X,Y) is permittivity along X-Y axes of the twisted waveguide at the frequency f, respectively, L is the waveguide's length, and θ is a twist angle of the waveguide.

In one aspect of the invention, the linear birefringence λ is a propagation constant difference β_{TE}-β_{TM} of TE and TM modes, respectively, within an untwisted waveguide having said permittivity profile.

Alternatively, the condition for elliptical birefringence can be formulated as follows: creating a twisted waveguide in which the pitch of the twist

$$Λ = \frac{2 π}{θ} L$$

has the same order of magnitude as the polarization beat length L_{B} in an untwisted waveguide having the same cross-section as said twisted waveguide.

In another aspect, the above-designed twisted waveguide is used as an elliptical polarizer.

Still, another aspect of the invention is that the above-designed twisted waveguide is used as a single qubit gate capable of performing unitary transformations on polarization qubits.

Still, another aspect of the invention is that the above-designed twisted waveguide is used as reconfigurable single-qubit gate configured to perform polarization encoding.

In another embodiment, the above-designed twisted waveguide is used as a reconfigurable single qubit gate capable of performing parameter-dependent unitary operations on polarization qubits.

In another aspect of the invention, one or more external signals are applied to reconfigure the twisted waveguide's physical parameters, thereby modifying the unitary operation it performs.

The twisted waveguide 100 of the invention can be used as a reconfigurable waveplate, capable of elliptical polarization transformation of either classical or quantum light.

In one example, one or more external voltage or temperature reconfiguration signals are applied to the twisted waveguide to modify birefringence A or, equivalently, polarization beat length L_{B}.

In one example, said external signals are temperature of the chip or voltage or current at electrodes deposited onto the chip containing the waveguide or combination thereof.

Still, another aspect of the invention is that the above-designed twisted waveguide is used within a system for forming arbitrary polarizations.

In one aspect of the invention, a plurality of twisted waveguides 100, all having a same cross section, but possibly different L and θ, each twisted waveguide being controlled with its own independent external signal 130, are stacked, and the signals 130 are tuned to achieve arbitrary polarization transformation.

### Further Discussion and Examples

The inventors developed a rigorous theory for unveiling twisted waveguide eigenmodes and transmission matrices in a closed form. The inventors use this developed theory to demonstrate that twisted waveguides can realize virtually arbitrary polarization transformations while satisfying reasonable design constraints. This theory, combined with the low cost and ease of prototyping of laser-inscribed photonic integrated circuits, demonstrates that a twisted waveguide can be used as a robust building block for on-chip polarization-encoded information processing.

One or more of the photon's physical degrees of freedom, such as path, angular momentum, and polarization, can be applied to encode information in a single photon level. A higher information processing capability per chip footprint advises using the maximum possible number of them. Photon polarization is an always-available natural degree of freedom and is thus among the most widely used encoding mechanisms. It is crucial to perform most or ideally all light manipulations on a chip to benefit from using an integrated platform, as most losses occur when coupling light into a chip or from a chip. However, despite the recognized strength of integrated photonics in controlling light, manipulating polarization on a chip remains elusive.

Although integrated photonic polarization-encoded CNOT gate has been demonstrated in laser-written chips, prior art polarization manipulations were performed using bulk or fiber optics. On-chip polarization manipulation schemes based on tilted basis waveguides are typically used serving as waveplates where the waveguide symmetry axis exhibits the optical axis. Such schemes, however, suffer from several drawbacks: they are susceptible to fabrication tolerances and tend to have significant coupling losses due to the cross-section mismatch with conventional waveguides.

Following the recent advances in integrated photonics fabrication technology, especially in laser writing, integrated photonic twisted waveguides have become a reality and have already been suggested as broadband adiabatic polarization rotators. Several effects were observed in twisted waveguides, which cannot be easily explained by the adiabatic mode evolution principle: a decrease in polarization conversion efficiency with increased twist length and spectral oscillations of polarization conversion efficiency. Explaining these effects requires a rigorous theoretical description of polarization dynamics in a twisted waveguide, which the inventors have now developed.

The inventors' analysis shows that twisted waveguides can perform arbitrary polarizations, in addition to linear polarization rotations, due to an optical activity arising from the interplay of structural linear and circular birefringence. This observation enables the utilization of twisted waveguides as on-chip elliptical waveplates capable of implementing arbitrary unitary operations in polarization-encoded quantum and classical information processing circuits. The inventors developed an analytical model that significantly facilitates the prototyping of twisted waveguide-based devices, gives deep insight into the underlying physics, and allows quick multi-parameter optimizations. Furthermore, by fabricating twisted waveguides by the femtosecond laser inscription technology, which combines low-cost fabless and maskless fabrication process with excellent design flexibility, the twisted waveguide exhibits a promising building block for the experimental realization of polarization-encoded quantum information processing integrated circuits.

The coupled-mode theory for a twisted waveguide is now described.

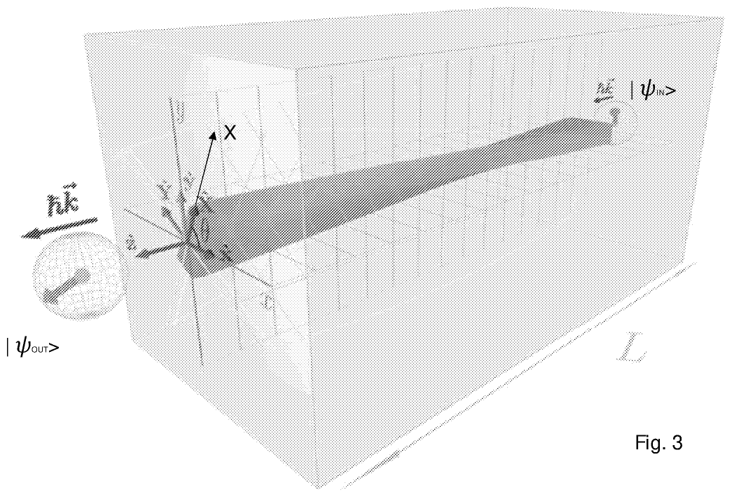

FIG. 3 schematically illustrates a twisted waveguide realizing a polarization-encoded single-qubit gate. The notation L indicates the twist length, and θ indicates the twist angle. The input and output single-photon states ψᵢₙ and ψₒᵤₜ are represented as positions on the respective Bloch spheres.

Expressing Maxwell's equations in a helical reference frame and taking into account the helical symmetry of a twisted waveguide, the following operator equation (1) is obtained:

$$i \frac{\partial }{\partial z} \vec{F} = G \vec{F} , \qquad ( 1 )$$

where \vec{F} is a four-component vector of transverse electric and magnetic fields, and G is a z-independent evolution operator. It is possible to separate variables in Eq. (1) as \vec{F}(r)=\vec{f}(r_{⊥})e^{-iβz} where the radius-vector r is expanded in transversal and longitudinal components as r=r_{⊥}+z\hat{z} with the transverse radius-vector r_{⊥} expanded in helical basis as r_{⊥}=X\hat{X}+YŶ. The transverse basis vectors {\hat{X},Ŷ} of the helical reference frame as well as the basis vectors {\hat{x}, ŷ, \hat{z}} of the Cartesian laboratory frame are depicted in FIG. 3. The separation of variables leads to the eigenmode equation for the vector \vec{f}(r_{⊥}) and the eigenvalue β. For the waveguide composed of isotropic materials, the eigenmode equation can be derived in an alternative way: from the wave equation in terms of either magnetic or electric fields, eliminate the longitudinal field, obtaining the eigenmode equation for the transverse fields. Such formulated eigenmode equation has a dimensionality of two, giving benefits for numerical implementation. The eigenmode equation for the transverse electric field is therefore written as

$$L ( β , α ) \vert ψ = 0 , \qquad ( 2 )$$

where L(β,α) is the equation operator quadratic both in the eigenvalue β, and the twist rate α=θ/L, where θ and L are the twist angle and length, respectively, as shown in FIG. 3.

The inventors denoted by |ψ> the transverse modal electric field expanded in helical frame as <r_{⊥}|ψ>=eₓ\hat{X}+e_{y}Ŷ while using ket- and bra-vectors as a convenient notation for classical modes. The classical modes, however, have a tight relation to the quantum states, as we pointed out later. The operator L(β,α) reads as

$$L ( β , α ) = A - {β}^{2} + α V ( β ) + {α}^{2} D \qquad ( 3 )$$

$$with$$

$$V ( β ) = 2 i ( {β}^{- 1} B + β C ) , \qquad ( 4 )$$

where A, B, C, D are the two-dimensional operators depending on X, Y and their derivatives with A=H₀ coinciding with the eigenvalue equation operator for an untwisted waveguide in the laboratory frame.

The operator L in Eq. (3) poses a polynomial eigenvalue problem which, even though it can be solved directly, the inventors solved using a perturbative approach with respect to the small twist rate α. The perturbative approach allows the conversion of the polynomial eigenmode equation to the standard, i.e., linear eigenvalue equation, and to express the eigenmodes explicitly as functions of eigenmodes of an unperturbed (untwisted) waveguide and the twist rate α.

The following outlines a perturbative theory of twisted waveguides, which makes no assumptions on the waveguide geometry and relies solely on the fundamental property of orthogonality of the guided modes. Two simplifications can be established by considering the twist rate as a small perturbation parameter. First, V(β) in Eq. (3) can be approximated by V(β₀) where β₀ is the unperturbed eigenvalue. Second, the quadratic term α²D can be omitted. With these simplifications in hand, a linearized perturbative eigenvalue problem is formulated as follows:

$$H \vert ψ >= {β}^{2} \vert ψ > , H = {H}_{0} + α V ( {β}_{0} ) . \qquad ( 5 )$$

Since the eigenvalues of guided modes are very close, especially for polarization modes, the normal perturbation theory fails. It is, however, possible to find the perturbed modes in terms of the coupled mode theory, looking for them in the form of linear combinations of the unperturbed modes

$$\vert {τ}_{v} >= {\sum }_{μ = 1}^{N} {M}_{μ v} \vert μ > , \qquad ( 6 )$$

where columns of M_{μv} correspond to expansion coefficients of the v-th twisted mode |ψ>=|τv> over the eigenstates of the unperturbed Hamiltonian H₀, the untwisted modes |μ>, with N being the number of modes.

By substituting Eq. (6) into Eq. (5) and using orthogonality of the unperturbed modes <μ|v>=δ_{μv}, the problem of finding perturbed modes |τᵥ> can be reduced to the problem of diagonalization of the Hamiltonian matrix H_{μv}=μ|H|v> in the basis of the unperturbed modes, while the matrix elements constitute overlap-type integrals.

The perturbation operator V and the inner products constituting the matrix elements can be calculated analytically if the unperturbed modes are either known analytically or possess symmetries. In general, the perturbation operator can be implemented numerically by approximating the derivatives with matrices using the Finite Difference Method. At the same time, the unperturbed modes can also be calculated with the Finite Difference Method or some other method, such as the Finite Element Method.

The single-mode operation of a twisted waveguide is now described. It is instructive to consider a single-mode twisted waveguide since, by doing so, it is possible to determine the matrix elements <μ|V|v > explicitly imposing the following reasonable assumptions. Firstly, if the waveguide's cross-section defined by the permittivity profile ε(X,Y) is rectangular or, more generally, the function ε(X,Y) is even relative to both X and Y, the modal profiles must be either even or odd functions of X and Y.

Secondly, it is considered that the twist does not cause mode leakage, so the matrix V and the Hamiltonian matrix H are Hermitian. Finally, it is assumed that the twisting axis coincides with the center of the waveguide, that is, its symmetry in helical coordinates is unbroken. Then, the symmetries restrict integrands in diagonal matrix elements <μ|V|μ> to be odd functions, causing these matrix elements to vanish while the off-diagonal elements are complex conjugates to each other <1|V|2>=<2|V|1>*. Here, the unperturbed states |1> and |2> are orthogonally polarized states |H> and |V>, respectively. By calculating the only remaining nontrivial matrix element <1|V|2> it is revealed that the matrix V is proportional to the Pauli-Y matrix:

$$< μ \vert V \vert v >= ( \begin{matrix}0 & - 2 i \overline{β} \\ 2 i \overline{β} & 0\end{matrix} ) = 2 \overline{β} {σ}_{y} , \qquad ( 7 )$$

where β̅=(β_{H}+β_{V})/2 is the average propagation constant. The Hamiltonian matrix:

$$μ Hv = ( \begin{matrix}{β}_{H}^{2} & - 2 i α \overline{β} \\ 2 i α \overline{β} & {β}_{V}^{2}\end{matrix} ) \qquad ( 8 )$$

has a couple of eigenvalues

$${β}_{1.2} = \overline{β} \pm \frac{1}{2} \sqrt{{λ}^{2} + 4 {α}^{2}} .$$

Here λ=B_{H}−β_{V} is the linear birefringence in the untwisted waveguide reciprocal to the linear beat length as λ=2π/L_{B}. By introducing an angle ψ according to the definition:

$$tan ψ = 2 α / λ , \qquad ( 9 )$$

The eigenvalues and eigenvectors can be represented in the following compact form:

$${β}_{1 , 2} = \overline{β} \pm \frac{λ}{2 cos ψ} . and \qquad ( 10 )$$

$$\vert {τ}_{1} > = \frac{cos ψ}{2} \vert H > + i sin ψ / 2 \vert V > , \qquad ( 11 )$$

$$\vert {τ}_{2} > = \frac{i sin ψ}{2} \vert H > + cos ψ / 2 \vert V > , \qquad ( 12 )$$

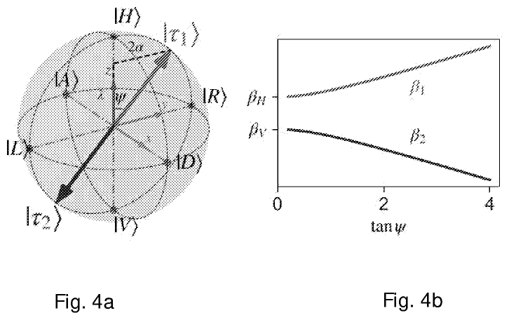

respectively. If a single-photon state is supplied to a twisted waveguide, the vectors |τ_{1,2}> can be naturally associated with polarization qubits. It is convenient to illustrate these states on the Bloch sphere in the form shown in FIG. 4(a).

FIG. 4a shows the eigenvectors, and FIG. 4b shows the eigenvalues of the eigenmodes of a twisted waveguide as a function of twist rate expressed in terms of the angle $, defined in Eq. (9).

The propagation constants (10) are shown in FIG. 4 (b). By comparing the expansions above with (6), it is easy to see that

$$M = ( \begin{matrix}cos ψ / 2 & i sin ψ / 2 \\ i sin ψ / 2 & cos ψ / 2\end{matrix} ) = exp ( i {σ}_{x} ψ / 2 ) \qquad ( 13 )$$

is the rotation matrix corresponding to the rotation of the Bloch sphere around the x axis by the angle ψ, where σₓ is the Pauli-X matrix. The expression (13) of the matrix M in terms of the Pauli matrix reveals the geometric meaning of ψ visualized in FIG. 4 (a). It should be noted that the rotation of the eigenmodes around the x axis is caused by the interplay of the linear birefringence λ induced by unequal cross-section dimensions and topological circular birefringence 2a induced by twisting.

At very slow twist rates, namely, when α<<λ, the angle ψ is close to 0° and the twisted waveguide modes coincide with horizontally |H> and vertically |V> polarized modes of the untwisted waveguide. On the other hand, at the rapid twist rates, when α>>λ, ψ approaches π/2 and the modes become circularly polarized, as |R> and |L> in FIG. 4(a). In any intermediate case, the polarization is elliptical, being the mixture of linear and circular contributions. Noteworthy, in the case of zero linear birefringence, the theory reproduces linear eigenvalue separation β1-β2=2α as predicted by degenerate perturbation theory isomorphic to the theory of Zeeman effect in the weak magnetic field.

The transmission matrix of a single-mode twisted waveguide is now discussed. Knowing that a single-mode twisted waveguide operates as an elliptical waveplate, the inventors derived its Jones matrix or transmission matrix T in the waveguide terminology.

$$T : {ψ}_{out} = T {ψ}_{in} , \qquad ( 14 )$$

where |ψᵢₙ₍ₒᵤₜ₎=Hᵢₙ₍ₒᵤₜ₎|H>+Vᵢₙ₍ₒᵤₜ₎|V> are the input (output) polarization states, as shown in FIG. 3. The inventors immediately observed that since the twisted modes |τ_{1,2}> are the eigenmodes of T, the transmission matrix in their basis is diagonal <τᵥ|T|τ_{μ}>=exp(−iβ_{μ}L)δ_{μv}. After extracting the unimportant global phase factor exp(−β̅L) it was found that <τᵥ|T|τ_{μ}>=exp(−i σ_{z}φ/2), where φ=δβL, (δβ=β₁-β₂) is the accumulated phase difference between the modes or retardance. Using Eq. (10) the retardance can be written employing angle ψ and linear birefringence as φ=λL/cos ψ. Positions of the vectors |τ_{μ}> on the Bloch sphere are unchanged upon transformation T. This means that they lie on the axis of the rotation as depicted in FIG. 4(a). These geometrical considerations allow to immediately find the matrix elements of T in the basis {|H>,|V>};

$$< v \vert T \vert μ >= exp ( - i \hat{m} \cdot \vec{σ} ϕ / 2 ) , \qquad ( 15 )$$

where \hat{m}=\hat{z}cos ψ+ŷsin ψ is the unit vector along |τ₁>, \vec{σ}={σₓ, σ_{y}, σ_{z}} is the vector of Pauli matrices. This result can also be obtained algebraically using the unitary transformation <τ_{y}|T|τ_{μ}>=<v|M^{†}TM|μ>. It is emphasized that matrix elements (15) defined so far refer to the helical reference frame. To obtain the transmission matrix in the laboratory frame, the components are related in different bases |μ>=J|μ′> by means of the Jacobian matrix J=exp(−iσ_{y}αz), so that

$$< {v}^{′} \vert T \vert {μ}^{′} >= exp ( i {σ}_{y} θ ) exp ( - i \hat{m} \cdot \vec{σ} ϕ / 2 ) \qquad ( 16 )$$

are the matrix elements in the laboratory frame.

Therefore, transformation of polarization can be treated as a composition of two subsequent Bloch sphere rotations: first, rotation about the |τμ> line as seen from the helical reference frame and, second, rotation of the basis vectors of the helical frame about the y axis of the Bloch sphere by 2θ. To express T as a single rotation, the inventors composed two rotations exp(iσ_{y}θ) and exp(−i\hat{m}·\vec{σ}φ/2)

$$T = exp ( - i \hat{n} \cdot {\vec{σ}}_{χ} / 2 ) , \qquad ( 17 )$$

where the angle X and the axis \hat{n} are defined by the waveguide parameters θ, ψ, and φ as

$$cos \frac{χ}{2} = cos θ cos \frac{ϕ}{2} + sin θsin \frac{ϕ}{2} sin ψ , {n}_{x} sin \frac{χ}{2} = cos ψ sin θsin \frac{ϕ}{2} , {n}_{y} sin \frac{χ}{2} = cos \frac{ϕ}{2} sin θ + cos θsin \frac{ϕ}{2} sin ψ , {n}_{z} sin \frac{χ}{2} = cos θcosψ sin \frac{ϕ}{2} . \qquad ( 18 )$$

In the slow twisting regime (ψ→0), the gate T, as follows from Eq.(18), reduces to the rotation about the y axis by the angle 2θ: T→exp(−iσ_{y}θ).

Interestingly, in Z.-S. Hou, X. Xiong, J.-J. Cao, Q.-D. Chen, Z.-N. Tian,X.-F. Ren, and H.-B. Sun, “On-Chip Polarization Rotators”, Advanced Optical Materials 7, 1900129 (2019), the authors observed slight ripples in polarization conversion dependence on the twist length, the amplitude being larger at smaller twist lengths. Those ripples can be explained as departure from the linear birefringence regime equivalent to the presence of effective optical activity (ψ≠0). Such an effect can also be related to the spectral oscillations of polarization conversion efficiency experimentally observed for laser-inscribed twisted waveguides. The spectral dependency of polarization conversion arises due to significant circular birefringence and inherits an elliptical waveplate effect in a low birefringence borosilicate glass platform. In the case of dominant circular birefringence (ψ→π/2) it can seen that the gate reduces to unity, T→1, because the optical activity in helical fibers appears only if the fiber possesses some linear birefringence. That is why a square twisted waveguide would not affect the polarization.

The absence of polarization conversion may have a useful application: short mode adapters can be inserted at the facet of the twisted waveguide to compensate for cross-section mismatch (which may appear if oblique twist angles are used) without affecting the gate performance.

Arbitrary waveplates and single-qubit gates are now discussed. The inventors estimated the capability of twisted waveguides to perform arbitrary polarization transformations. The inventors posed an inverse design problem to estimate this capability: For a given target unitary operator, namely, a Bloch sphere rotation with given Euler angles, find the twisted waveguide realization defined by two parameters: the length L in terms of linear beat lengths L_{B} and the twist angle θ. To quantify the quality of the realized operations, the inventors used a single-qubit gate fidelity measure

$$F = \frac{1}{2} + \frac{1}{12} {\sum }_{j = x y , z} Tr ( T {σ}_{j} {T}^{†} U {σ}_{j} {U}^{†} )$$

proposed in M. D. Bowdrey, D. K. L. Oi, A. J. Short, K. Banaszek, and J. A. Jones, “Fidelity of Single Qubit Maps”, Physics Letters A 294, 258 (2002), arxiv:quant-ph/0201106, where U is the target gate, and T is its twisted waveguide realization as defined by Eq. (17) and (18). F measures the average deviation of the

$$\vert {ψ}_{out}^{actual} >= T \vert {ψ}_{i n} >$$

from the target state

$$\vert {ψ}_{out}^{target} > = U \vert {ψ}_{in} >$$

among a set of all possible input states |ψᵢₙ>. The inventors first parametrized rotation axis \hat{n} in Eq. (18) in spherical coordinates ϑ and φ as \hat{n}=sin ϑ cos φ\hat{x}+sin ϑ sin φŷ+cos ϑ\hat{z} establishing the relation between the Euler angles {ϑ, φ,X} and design parameters {θ, ψ, φ}

$$cos \frac{χ}{2} = cos θ cos \frac{ϕ}{2} + sin θsin \frac{ϕ}{2} sin ψ , sin ϑcosφsin \frac{χ}{2} = cos ψ sin θsin \frac{ϕ}{2} , sin ϑcosφsin \frac{χ}{2} = cos \frac{ϕ}{2} sin θ + cos θsin \frac{ϕ}{2} sin ψ , cos ϑsin \frac{χ}{2} = cos θcosψ sin \frac{ϕ}{2} . \qquad ( 19 )$$

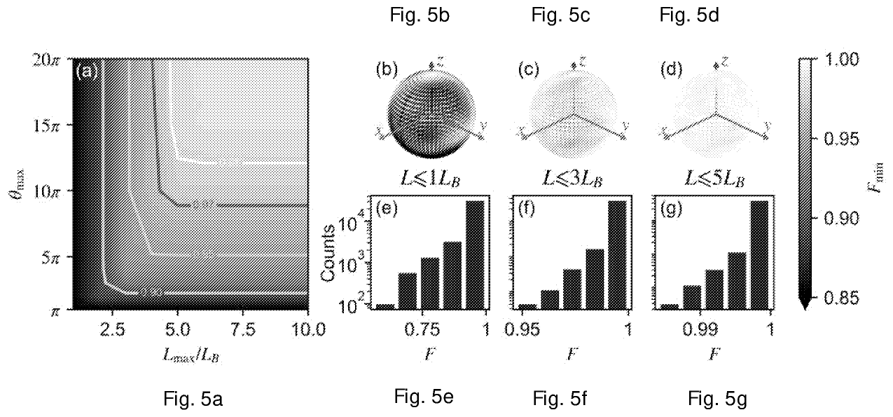

Then, the inventors swept φ and X from 0 to 2π and D from 0 to π, effectively covering a discrete grid of all possible single qubit gates. The grid dimensions were 33×65×17 for polar, azimuthal, and rotation angles, respectively, thus giving the total number of target gates equal 36465. For the optimization results to be of practical significance, the inventors constrained the maximum twisted waveguide length L and twist angle θ and calculated the worst fidelity Fₘᵢₙ over a set of target operators for different values of the constraints Lₘₐₓ, Bₘₐₓ. FIGS. 5a-5g generally show a twisted waveguide approximation of arbitrary single-qubit gates and summarize the analysis results among all the designs. FIG. 5(a) shows the worst fidelity Fₘᵢₙ overall single qubit gates as a function of twisted waveguide design constraints, where θₘₐₓ is the maximum twist angle, and Lₘₐₓ is the maximum twist length measured in terms of linear beat lengths L_{B}. FIGS. 5a-5d show the worst fidelity over rotations around a given axis with θₘₐₓ=20Π and three different Lmax constraints. FIGS. 5a-5g show, respectively, histograms (e-g) below the spheres visualizing the distribution of fidelities.

A monotonic improvement of Fₘᵢₙ can be seen for the increase of both θₘₐₓ and Lₘₐₓ guarantying, for instance, fidelity greater than 0.95 for Lₘₐₓ>5L_{B} and θₘₐₓ>5π for any operation. The worst fidelities for the approximations of rotations around different axes for θₘₐₓ=20π and three values of L are illustrated in FIGS. 5b-5d. The position of points on spheres in these figures is associated with the rotation axis, while the colors correspond to the worst fidelity across a set of rotation angles [X in Eq. (17)] for this axis. The bar charts in FIGS. 5e-5g show the fidelity distributions. For the considered constraints, the fidelities appear to group near the unity, whereas increasing the maximum length L narrows the distribution. The results demonstrate that the absolute majority of gates can be approximated with fidelity >0.95, while the twisted waveguides are restricted to a few linear beat lengths with a twist angle of 20π (10 total twists). State-of-the-art laser-written waveguides typically exhibit birefringences δn~10⁻⁵-10⁻⁴ in terms of modal indices depending on the particular fabrication process and cross-section dimensions. Such a birefringence ensures the linear beat length L_{B}~8-0.8 cm at wavelength 800 nm. It was thus concluded that laser-written twisted waveguides implementing any possible single qubit gate have comparable sizes to the laser-written architectures reported earlier.

A possible way to reduce the size of gates is to stack several twisted waveguides. More design parameters exist in this case, providing higher fidelities at a more compact size. For instance, a single twisted waveguide implementing Pauli-X operation with fidelity 0.992 has a length 4.473L_{B} while a waveguide composed of two stacked waveguides—α π/2-twisted waveguide of the length 0.866L_{B} implementing Pauli-Y operation and a straight waveguide of the length 0.5L_{B} implementing Pauli-Z operation, has a total length of 1.366L_{B}, while implementing Pauli-X with unit fidelity.

As discussed, the inventors developed a perturbation theory applicable to twisted waveguides of arbitrary cross-section. The inventors applied the theory to a single-mode rectangular twisted waveguide and have revealed analytical expressions for its eigenmodes and Jones matrices to gain a clear insight into the physics of twisted waveguides. The inventors also demonstrated the effectiveness of the theory in designing twisted waveguide-based elliptical waveplates and polarization-encoded single qubit gates by optimizing the twisted waveguide's parameters to implement arbitrary polarization transformations. While analyzing only single-qubit operations, twisted waveguides in quantum information processing is not limited by them: it is possible to realize multi-qubit maps using composite structures such as coupled twisted waveguides. Furthermore, by inscribing twisted waveguides in non-linear crystals, one can realize thermally, electrically, or optically reconfigurable quantum gates. The twisted waveguide, thereby, exhibits a promising on-chip polarization-manipulation building block.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. A method for creating a twisted waveguide capable of exhibiting elliptical birefringence, the method comprising:
for a given light frequency f and cross-section of a waveguide described by a permittivity profile ε(X,Y), calculating a linear birefringence λ, thereby to determine and apply parameters L, θ, and a twist rate θ/L that satisfy a condition that the twisted waveguide's twist rate is of a same order of magnitude as a linear birefringence rate occurred when assuming that the waveguide is untwisted;
where f is the frequency of light, ε(X,Y) is permittivity along X-Y axes of the twisted waveguide at the frequency f, respectively, L is the waveguide's length, and θ is a twist angle of the waveguide.

2. The method of claim 1, wherein said linear birefringence λ is a propagation constant difference β_{TE}-β_{TM} of TE and TM modes, respectively, within an untwisted waveguide having said permittivity profile.

3. The method of claim 1, wherein a pitch of the waveguide twist
$$Λ = \frac{2 π}{θ} L$$
has a same order of magnitude as a polarization beat length L_{B} of an untwisted waveguide having a same cross-section as said twisted waveguide.

4. The method of claim 1, further using the twisted waveguide as an arbitrary waveplate.

5. The method of claim 4, wherein the waveplate operates with classical light, and is reconfigurable.

6. The method of claim 1, further using the twisted waveguide as a reconfigurable single-qubit gate capable of performing unitary transformations on polarization qubits.

7. The method of claim 6, further using the twisted waveguide as a reconfigurable single-qubit gate configured to perform polarization encoding.

8. The method of claim 6, wherein said reconfiguration is performed by utilizing one or more external signals that modify said twisted waveguide's linear birefringence.

9. The method of claim 8, wherein said external signals are voltage or temperature modifying substrate material's refractive index affecting said linear birefringence of the twisted waveguide.

10. The method of claim 8, further stacking a plurality of twisted waveguides, all having a same cross section, but possibly different L and 0, each twisted waveguide being controlled with its own independent external signal, and further tuning said signals to achieve arbitrary polarization transformation.

11. A twisted waveguide created to exhibit an elliptical polarization transformation, wherein the waveguide is designed such that:
for a given light frequency f, cross-section of the waveguide described by a permittivity profile ε(X,Y), and linear birefringence λ within the waveguide, providing parameters L, θ, and a twist rate θ/L that satisfy a condition that the twisted waveguide's twist rate is of a same order of magnitude as a linear birefringence occurred when assuming that the waveguide is untwisted;
where f is the frequency of light, ε(X,Y) is permittivity along X-Y axes of the twisted waveguide, respectively, L is the waveguide's length, and θ is a twist angle of the waveguide.

12. The twisted waveguide of claim 11, wherein a pitch of the waveguide twist
$$Λ = \frac{2 π}{θ} L$$
is of a same order of magnitude as a polarization beat length L_{B} of an untwisted waveguide having a same cross-section.

13. The twisted waveguide of claim 11, configured to operate as an arbitrary waveplate.

14. The twisted waveguide of claim 11, wherein the waveplate is configured to operate with classical light, and is reconfigurable.

15. The twisted waveguide of claim 11, configured to operate as a single-qubit gate with polarization qubits.

16. The twisted waveguide of claim 11, which is reconfigurable to provide polarization encoding.
